(19) United States
(12) Patent Application Publication
(10) Pub. No.: US 2025/0296204 A1
(43) Pub. Date: Sep. 25, 2025

(54) Line Nut Remover

(71) Applicant: Tyler Edwin Kolybaba, Lashburn (CA)

(72) Inventor: Tyler Edwin Kolybaba, Lashburn (CA)

(21) Appl. No.: 18/615,073

(22) Filed: Mar. 25, 2024

(51) Int. Cl. B25B 13/48

(52) U.S. Cl. CPC B25B 13/481

(57) ABSTRACT

A line nut remover is provided. The line nut remover includes two linkages connected to each other and each linkage has tight clearance offset sockets, also known as “crows foot wrenches.” One of the linkages includes a drive receiver able to receive a torque. When each offset socket is engaged with a line nut, the configuration of the line nut remover enables a first force applied to the drive receiver to loosen at least one of the line nuts in a single actuation. Simultaneously, the application of an opposing second force is able to cause the tightening of at least one of the line nuts. The line nut remover eliminates the need for multiple wrenches to be used simultaneously to tighten or loosen line nuts. This tool is particularly advantageous for mechanics and pipefitters working with various line connections in confined spaces where traditional tools are impractical.

### BACKGROUND OF THE INVENTION

The present invention relates to tools used for loosening and tightening nuts, particularly to a tool designed for use in confined spaces where traditional wrenches are impractical or more difficult to use. More specifically, the invention pertains to a tool that simplifies the process of loosening line nuts from connectors in hydraulic and other fluid systems.

In the maintenance and repair of hydraulic systems, mechanics and technicians often encounter the challenge of loosening line nuts that secure hydraulic lines to various components. Traditional methods typically require the use of two wrenches: one to turn the line nut and another to hold in place or rotate in an opposing direction. This method is not only cumbersome but also impractical in confined spaces.

Within confined spaces the requirement for multiple tools to accomplish a single task, and the lack of adaptability to different sizes and types of connections, often makes implementation of this method impossible. These limitations not only increase the time and effort required to perform maintenance tasks but also raise the risk of damage to the components or injury to the user.

Additional limitations of current tools underscore the need for an innovative solution that can more effectively address these challenges. The requirement for multiple tools not only complicates the task but also increases the risk of damage to the components or injury to the user due to the awkward positions and significant force often necessary to achieve the desired result. Furthermore, the lack of a single tool capable of adapting to various sizes and types of connections has been a notable gap in the market.

The development of a new tool that simplifies the process of loosening and tightening line nuts represents a significant advancement in addressing these issues. By combining the functionality of two wrenches into a single, more manageable tool, the line nut remover allows for the application of force in a manner that applies opposing forces to the line nuts which provides for the tightening and/or loosening of the line nut in a single action. This eliminates the need for multiple tools but also significantly reduces the manual effort required from the user.

In view of these developments, there exists a need for a tool that can efficiently loosen line nuts from connectors in a single action without requiring the use of multiple, cumbersome tools. The line nut remover is adaptable to various sizes and types of nuts and connectors and is capable of operating effectively in confined spaces. The line nut remover is configured to reduce the physical effort required from the user, minimize the risk of component damage or personal injury, and streamline the maintenance and repair process of hydraulic and other fluid systems. The line nut remover addresses these needs by providing a single, versatile tool that enables the loosening of line nuts from connectors with a single action.

In light of the devices disclosed in the known art, it is submitted that the present invention substantially diverges in design elements and methods from the known art and consequently it is clear that there is a need in the art for an improvement in line nut removers. In this regard the instant invention substantially fulfills these needs.

### SUMMARY OF THE INVENTION

In view of the foregoing disadvantages inherent in the known types of wrenches now present in the known art, the present invention provides a new line nut remover wherein a pair of linkages pivotally connected provides for pivotal movement that is capable of tightening the line nut or loosening the line nut depending on the application of a twisting force to the drive receiver. This design eliminates the need for multiple wrenches and is adaptable to various sizes and types of connections, ensuring broad applicability.

It is an objective of the present invention to offer a line nut remover that simplifies the process of loosening and tightening line nuts in hydraulic and other fluid systems. This is achieved by integrating a mechanism that allows for the application of force in confined spaces without requiring multiple long handle wrenches to be used simultaneously.

It is an objective of the present invention to offer a line nut remover that can be effectively used in confined spaces where traditional wrenches are impractical. The compact and efficient design of the line nut remover enables operation in tight spaces, addressing a common challenge faced by mechanics and pipefitters in accessing and manipulating line nuts and connectors in restricted areas.

It is an objective of the present invention to offer a line nut remover that improves the safety and efficiency of operations involving the loosening and tightening of line nuts. By providing a tool that requires less physical force and reduces the need for awkward positioning, the invention aims to minimize the risk of injury to the user and damage to the components, thereby enhancing operational safety and efficiency.

It is an objective of the present invention to offer a line nut remover that is adaptable to various sizes and types of connections. By incorporating adjustable components or attachments, the line nut remover is capable of engaging with a wide range of nut and connector sizes, enhancing its versatility and utility across different systems and standards such as JIC, SAE, ORFS, ORB, NPT, and BSP.

It is therefore an object of the present invention to provide a new and improved line nut remover that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead view of a first embodiment of the line nut remover engaged with pair of line nuts.

FIG. 2 shows an exploded view of the first embodiment of the line nut remover.

FIG. 3 shows a perspective view of the first embodiment of the line nut remover in operation within a confined space.

FIG. 4 shows a perspective view of a second embodiment of the line nut remover.

FIG. 5 shows an exploded view of the second embodiment of the line nut remover.

### DETAILED DESCRIPTION OF THE INVENTION

Reference is made herein to the attached drawings. Like reference numerals are used throughout the drawings to depict like or similar elements of the system. For the purpose of presenting a brief and clear description of the present invention, the embodiment discussed will be used for loosening and tightening nuts for an automobile in a confined space. The figures are intended for representative purposes only and should not be considered to be limiting in any respect. Furthermore, the described features, structures, or characteristics may be combined in any suitable manner in one or more embodiments. In the following description, numerous specific details are provided to give a thorough understanding of embodiments.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment,” “first embodiment,” “second embodiment,” or “third embodiment” does not necessarily refer to the same embodiment.

As used herein “line nut” includes a form of a nut, which is a type of fastener characterized by a threaded hole. Nuts, in general, are designed to be fastened onto a corresponding bolt, screw, or other external threaded fastener to provide a secure means of assembly for various components. The nut has an internal threading which allows it to be twisted onto a bolt, screw, or other fastener with matching external threading, thereby creating a tight and secure joint. The term “line” in “line nut” specifies the particular application or context in which this nut is used. Unlike standard nuts that may be used across a wide range of applications, a line nut is specifically positioned on a pipe, hose, or line. These lines are typically part of a fluid transfer system, such as hydraulic, pneumatic, or fluid conveyance systems, and are used to transport various substances, including gases, liquids, and hydraulic fluids. The “line nut” also includes a nut that is permanently or semi-permanently secured to the pipe, hose, and the like, and any element that engages otherwise engages with a wrench. The description of a “line nut” also includes a “connector” which is a fixture commonly found towards an end of a hose, pipe, or tube that provides a fixed point to tighten or loosen a nut therewith.

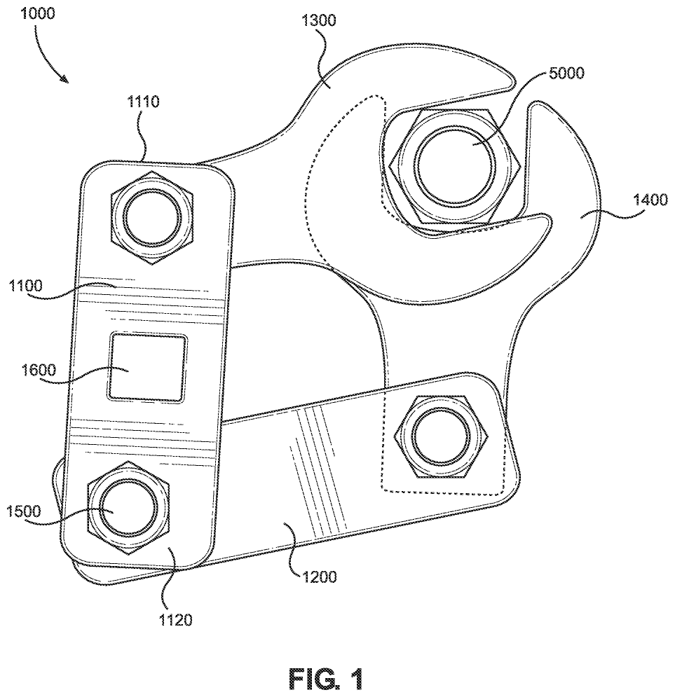

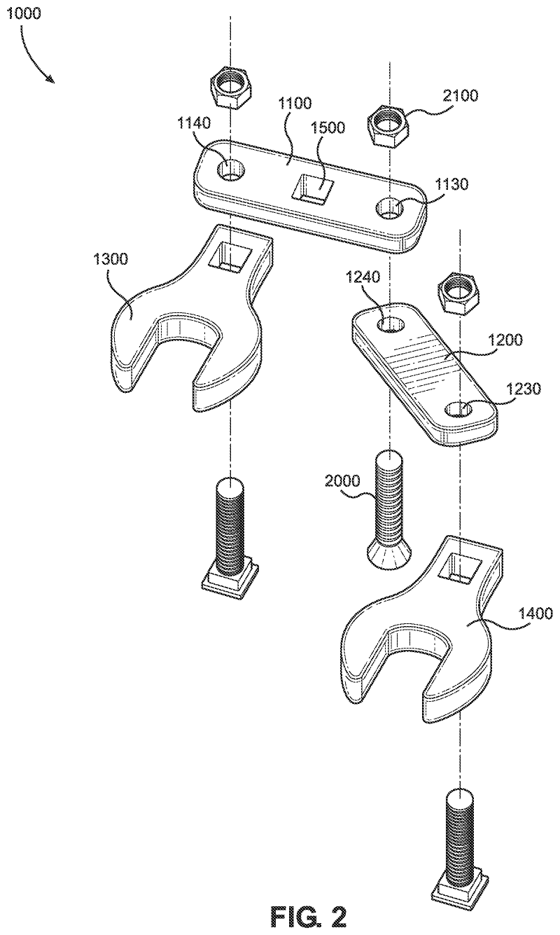

Referring to FIGS. 1 and 2, there is shown an overhead view of a first embodiment of the line nut remover engaged with pair of line nuts and an exploded view of the first embodiment of the line nut remover, respectively. The line nut remover 1000 provides for the loosening and tightening of line nuts 5000, which are commonly encountered in various mechanical and plumbing systems. The line nut remover 1000 comprises a first link 1100 connected to a second link 1200, wherein each link 1100, 1200 has an offset socket 1300, 1400, wherein each offset socket 1300, 1400 is configured to engage with the line nut 5000 in an engaged configuration. A pivot joint 1500 connects the first and second links 1100, 1200 and is configured to provide pivotal movement between the offset sockets 1300, 1400. The pivot joint 1500 serves as a fulcrum for the pivotal movement between the offset sockets 1300, 1400 and also facilitates the transfer of applied torque from a drive receiver 1600 to the engaged line nuts.

In the shown embodiment, the first link 1100 comprises a first end 1110 and a second opposing end 1120, wherein the second end 1120 of the first link 1100 is pivotally connected to the first end 1210 of the second link 1200. The pivot joint 1500 comprises a first fastener aperture 1130 disposed at the second end 1120 of the first link 1100 and a second fastener aperture 1240 disposed at the first end 1210 of the second link 1200, wherein a fastener 2000 is adapted to pass through the first and second fastener apertures 1130, 1240 to pivotally secure the links 1100, 1200 to each other.

In one embodiment, the first link 1100 includes a first end 1110 and a second end 1120 having a first aperture fastener 1130 and third aperture fastener 1140, respectively. The second link 1200 includes a first end 1210 and a second end 1220 having a second aperture fastener 1240 and fourth aperture fastener 1230, respectively.

As shown in FIG. 2, each offset socket 1300, 1400 is secured to the first and second link 1100, 1200 respectively via a removable fastener 2000. The removable fastener 2000 is a bolt having exterior threading that is sized to fit within the fastener apertures 1130, 1240. A nut fastener 2100 is used on the opposing side of the links 1100, 1200 to removable secure the removable fastener 2000 thereto. In this manner, the links 1100, 1200 are pivotally connected a rotate about fastener 2000.

In the shown embodiment, the drive receiver 1600 is disposed on the first link 1100, wherein the drive receiver 1600 is adapted to receive a torque and transfer the torque to the offset sockets 1300, 1400 to tighten or loosen the line nuts in the engaged configuration. In the shown embodiment, the drive receiver 1600 comprises a ½″ square drive that protrudes from between a first end 1110 and a second end 1120 of the first link 1100. In one embodiment, the drive receiver 1600 is positioned equidistant between the first and third aperture fasteners of the first link. In other embodiments, the drive receiver 1600 may have any suitable shape, size, or dimension that receives the drive.

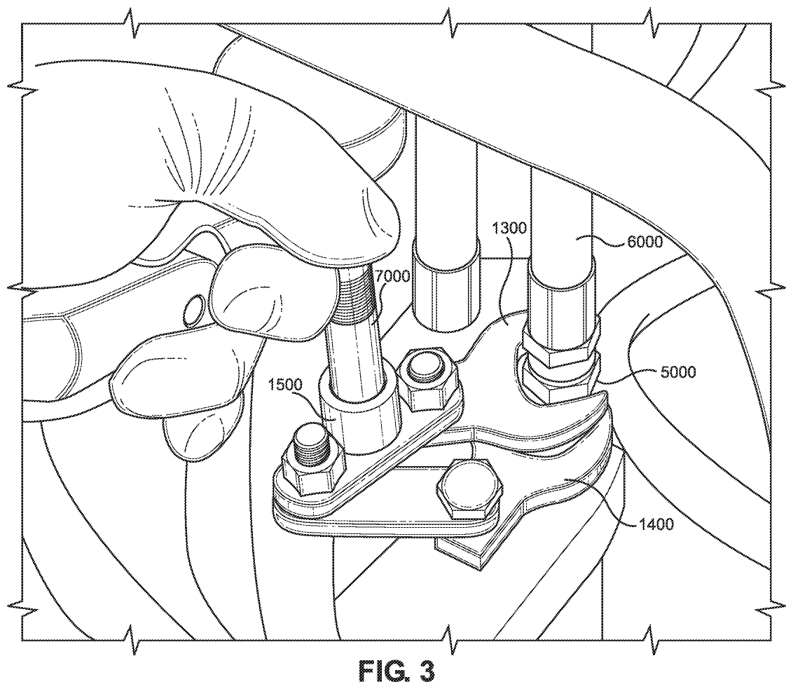

Referring to FIG. 3, there is shown a perspective view of the first embodiment of the line nut remover in operation within a confined space. In one exemplary operation, the line nut remover 1000 is being used to loosen a line nut 5000 positioned at an end of a tube 6000, to disconnect the tube 6000 from an assembly. Each offset socket 1300, 1400 is receiving a connector (not shown) and the line nut 5000, respectively. A torque wrench 7000 is engaged with the drive receiver 1600 on the first link 1100. As the torque wrench 7000 is rotated in a first direction, the driver receiver 1600 receives a torque from the torque wrench 7000. This torque is then transferred through the linkage assembly 1100, 1200 to the offset sockets 1300, 1400, which are in engagement with the line nuts 5000. Thereby, this action enables the loosening or tightening of these line nuts in a single actuation.

In the illustrated embodiment, the line nut remover does not include a handle to be grasped by the user. This allows the present invention to be utilized in confined spaces that do not allow for a large rotational radius. The distal ends of the first and second links 1100, 1200 terminate at the pivot joint 1500. In the shown embodiments, the first link and the second link comprise substantially a same length.

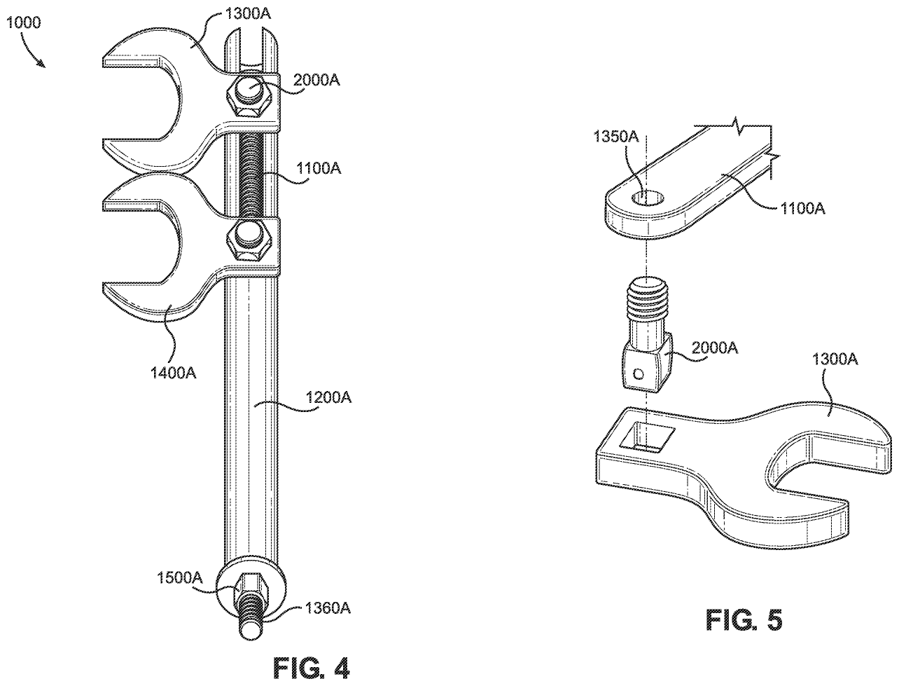

Referring to FIGS. 4 and 5, there is shown a perspective view of a second embodiment of the line nut remover and an exploded view of the second embodiment of the line nut remover, respectively. In the shown embodiment, the line nut remover 1000 comprises a first link member 1100A and a second link member 1200A. The first link member 1100A is a threaded rod that is connected to the second link member 1200A at an end thereof. The second link member 1200A is characterized as a hollow tube, such that it can receive the first link member 1100A therein. The tube 1200A is sized to receive the threaded rod 1100A through its first end 1360A, allowing the rod to extend through and beyond the tube (as seen in FIG. 4), thereby forming a drive receiver 1500A at the protruding end. Each link member 1100A, 1200A includes an offset socket, wherein the first offset socket 1300A is attached to the top end of the threaded rod 1100A via a pivot joint 1350A. The pivot joint 1300A provides for pivotal movement of the first offset socket 1300A. As shown in FIG. 5, the first offset socket 1300A is secured to the first link member 1100A via a pivot bolt fastener 2000A that extends through a pivot aperture 1350A. This pivotal movement provides for the operation of the device, enabling the application of torque in a manner that applies opposing forces to the line nuts engaged by the offset sockets. In one embodiment, the second offset socket 1400A is positioned in a fixed location on the hollow tube, providing a stable point against which the opposing force can be applied.

In one exemplary usage, upon engaging the first and second offset sockets 1300A, 1400A with the line nuts to be tightened or loosened, the user applies torque to the drive receiver 1500A at the end of the threaded rod 1100A. This action causes the threaded rod 1100A to rotate, which, due to the engagement of the threads within the hollow tube, results in the rod moving longitudinally. As the rod moves, the pivot joint 1500A and the attached first offset socket 1300A are drawn towards the fixed second offset socket 1400A. This movement applies a controlled and precise opposing force to the line nuts, effectively loosening or tightening them as required. The pivotal action of the first offset socket, facilitated by the pivot joint, ensures that the applied force is optimally distributed, minimizing the risk of damage to the line nuts or the connectors. In the shown embodiment, the line nut remover 1000 comprises a single handle member for both sockets.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A line nut remover, comprising:
a first link connected to a second link, each link having an offset socket;
wherein each offset socket is configured to engage with a line nut in an engaged configuration;
a pivot joint connecting the first and second links configured to provide pivotal movement between the offset sockets;
a drive receiver disposed on the first links, wherein the drive receiver is adapted to receive a torque and transfer the torque to the offset sockets to tighten or loosen the line nuts in the engaged configuration.

2. The line nut remover of claim 1, wherein the first link comprises a first end and a second opposing end, wherein the second end of the first link is pivotally connected to the first end of the second link.

3. The line nut remover of claim 2, wherein the pivot joint comprises a first fastener aperture disposed at the second end of the first link and a second fastener aperture disposed at the first end of the second link, wherein a fastener is adapted to pass through the first and second fastener apertures to pivotally secure the links to each other.

4. The line nut remover of claim 1, wherein each offset socket is secured to the first and second link respectively via a removable fastener.

5. The line nut remover of claim 1, wherein a third fastener aperture is disposed at the first end of the first link and a fourth fastener aperture the second end of the second link, wherein a fastener is adapted to pass through the third and fourth fastener apertures to secure the links to each offset socket.

6. The line nut remover of claim 5, wherein the drive receiver is positioned equidistant between the first and third aperture fasteners of the first link.

7. The line nut remover of claim 5, wherein each offset fastener comprises a square aperture at a base thereof that receives the removable fasteners and prevents rotation of the offset fastener relative to the respective link.

8. The line nut remover of claim 5, wherein each offset socket is independently adjustable relative to the respective link the offset socket is secured thereto.

9. The line nut remover of claim 5, wherein either offset sockets are adapted to the interchangeable with a third offset socket having a different dimensioned socket accommodate line nuts of various sizes.

10. The line nut remover of claim 1, wherein the drive receiver comprises a ½″ square drive.

11. The line nut remover of claim 1, wherein the pivot joint facilitates a pivotal action that enables the simultaneous tightening of the line nuts with a single applied force.

12. The line nut remover of claim 1, wherein the offset sockets are configured to engage with line including JIC, SAE, ORFS, ORB, NPT, or BSP connections.

13. A line nut remover, comprising:
a first link member connected to a second link member, each link having a first and second offset socket, respectively;
wherein each offset socket is configured to engage with a line nut in an engaged configuration;
a pivot joint configured to provide pivotal movement of at least one of the offset sockets;
a drive receiver operably connected to the first link member, wherein the drive receiver is adapted to receive a torque and transfer the torque to the offset sockets to tighten or loosen the line nuts in the engaged configuration.

14. The line nut remover of claim 13, wherein the first offset socket is attached to a top end of a threaded rod via the pivot joint.

15. The line nut remover of claim 14, wherein the second offset socket is in a fixed position.

16. The line nut remover of claim 14, wherein the first link member is a threaded rod that threadable engages and extends through the second link member, the second link member being a hollow tube sized to receive the threaded rod through a first end.

17. The line nut remover of claim 16, wherein the first link member extends through the first end of the second link member and forms the drive receiver.

18. The line nut remover of claim 17, wherein the engaged position, the line nut remover is configured to apply an opposing force to the line nuts received within the first and second offset sockets via an application of a first turning force through the drive receiver.
